(19) United States
(12) Patent Application Publication
(10) Pub. No.: US 2026/0284988 A1
(43) Pub. Date: Sep. 24, 2026

(54) METHOD FOR MANUFACTURING A COOLER

(71) Applicant: Dr. Ing. h.c. F. Porsche Aktiengesellschaft, Stuttgart (DE)

(72) Inventor: Patrick KNECHT, Stuttgart (DE)

(21) Appl. No.: 19/570,218

(22) Filed: Mar. 18, 2026

(30) Foreign Application Priority Data
Mar. 20, 2025 (DE) 10 2025 110 850.1

(51) Int. Cl. B29C 70/74; B23K 26/00; B23K 26/34; B23K 101/34; B23K 103/00; B23K 103/10; B29C 70/68; B29L 31/00

(52) U.S. Cl. CPC B29C 70/74; B23K 26/0006; B23K 26/34; B29C 70/682; B29C 70/683; B23K 2101/34; B23K 2103/10; B23K 2103/42; B23K 2103/52; B29L 2031/779

(57) ABSTRACT

A method manufactures a cooler having a cooler structure. The cooler structure includes a plurality of tubes arranged side by side and a first layer. The first layer extends between tubes of the plurality of tubes in a first axial portion of the tubes and connects the tubes to one another. The method includes the steps of: A) positioning, with a positioning device, the tubes arranged side by side in a basin having a powder for powder coating; and B) locally melting, by a laser beam, the powder in the first axial portion of the tubes arranged side by side, thereby forming the first layer from the molten powder.

### CROSS REFERENCE TO RELATED APPLICATIONS

This application claims benefit to German Patent Application No. DE 10 2025 110 850.1, filed on Mar. 20, 2025, which is hereby incorporated by reference herein.

### FIELD

The present disclosure relates to a method for manufacturing a cooler.

### BACKGROUND

JP S62-207 632 A shows a method for reducing manufacturing costs for a heat exchanger.

DE 102 51 658 B4 shows a method for joining materials suitable for producing microstructure components.

DE 11 2014 005 068 T5 shows a method of additive manufacturing using a fluidized bed.

EP 0 289 116 A1 shows a method for forming a shape using a laser.

WO 2005 032 708 A2 shows a method for producing a microchannel assembly.

### SUMMARY

In an embodiment, the present disclosure provides a method for manufacturing a cooler having a cooler structure. The cooler structure includes a plurality of tubes arranged side by side and a first layer. The first layer extends between tubes of the plurality of tubes in a first axial portion of the tubes and connects the tubes to one another. The method includes the steps of: A) positioning, with a positioning device, the tubes arranged side by side in a basin having a powder for powder coating; and B) locally melting, by a laser beam, the powder in the first axial portion of the tubes arranged side by side, thereby forming the first layer from the molten powder.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of a basin having a powder and a cooler structure according to an embodiment of the present disclosure;

FIG. 2 shows a spatial view of the cooler structure with tubes arranged side by side according to an embodiment of the present disclosure;

FIG. 3 shows a spatial view of the creation of a first layer of the cooler structure according to an embodiment of the present disclosure;

FIG. 4 shows a spatial view of the creation of a second layer of the cooler structure according to an embodiment of the present disclosure;

FIG. 5 shows a top view of the cooler structure according to an embodiment of the present disclosure; and

FIG. 6 shows a cooler having the cooler structure according to an embodiment of the present disclosure.

### DETAILED DESCRIPTION

Aspects of the present disclosure provide a new method for manufacturing a cooler.

An embodiment of the present disclosure provides a method for manufacturing a cooler having a cooler structure, wherein the cooler structure comprises a plurality of tubes arranged side-by-side and a first layer, wherein the first layer extends between the tubes in a first axial portion of the tubes arranged side-by-side and connects said tubes to one another, comprising the following steps:
A) the tubes arranged side-by-side are positioned with a positioning device in a basin having a powder for powder coating; and
B) the powder is locally melted in the first axial portion of the tubes arranged side-by-side by a laser beam, and the first layer is thereby formed from the molten powder.

The layer formed allows good tightness to be achieved. In addition, the use of the laser beam allows precise generation and also post-processing.

According to a preferred embodiment, the method for manufacturing the cooler structure having a second layer, wherein the second layer extends in a second axial portion between the tubes and connects said tubes to one another, wherein the second layer is at least partially spaced apart from the first layer at least in sections, comprises the steps of:
C) after step B), the position of the tubes arranged side-by-side in the basin is changed, the powder is locally melted in the second axial portion of the tubes arranged side-by-side by a laser beam, and the second layer is thereby formed from the molten powder.

This may create two spaced-apart layers that also allow for fluid separation in the area between the tubes.

According to a preferred embodiment, the method is carried out with tubes comprising at least one of the materials from a group of materials consisting of:
metal,
aluminum,
aluminum alloy,
ceramics,
plastic, and
polyether ether ketone (PEEK).

These materials are well suited for producing thin, at least largely dimensionally stable, tubes.

According to a preferred embodiment, the powder in the basin is swirled by a gas and thereby fluidized. In cooperation with the laser, this gives a reproducible result.

According to a preferred embodiment, during step B), the angle of incidence of the laser beam is altered relative to the tubes arranged side-by-side in order to locally melt the powder on different sides of the tubes.

According to a preferred embodiment, the cooler comprises a housing, wherein the cooler structure is inserted into the housing.

According to a preferred embodiment, the first layer abuts the housing 22 at least in sections. This increases a sealing effect in this area.

According to a preferred embodiment, the positioning device comprises a gripper, and the tubes arranged side-by-side are held by the gripper in step A).

According to a preferred embodiment, the tubes arranged side-by-side are heated in a pre-heating position before step A). This allows for an acceleration of manufacturing and an improvement of quality.

According to a preferred embodiment, the first layer is formed by the laser beam, such that it protrudes on the outside of the tubes arranged side-by-side.

According to a preferred embodiment, the first layer is formed by the laser beam in the area between the tubes arranged side by side, such that it fluidly separates the two axially opposite surrounding regions that are separated from one another by the first layer. This allows a seal in this area without any further action and results in a reduction in mass.

According to a preferred embodiment, a resin powder is used in the basin as the powder. This can be melted locally by a laser beam and allows for a material bonded connection.

According to a preferred embodiment, tubes having a first outer diameter are used as tubes arranged side by side at least partially, wherein the outer diameter is selected from an outer diameter group consisting of:
outer diameter in the range between 4 mm and 5 mm,
outer diameter in the range between 3 mm and 4 mm,
outer diameter in the range between 2 mm and 3 mm,
outer diameter in the range between 1 mm and 2 mm,
outer diameter in the range between 0.5 mm and 1 mm,
outer diameter in the range between 0.1 mm and 0.5 mm, and
outer diameter in the range between 0.01 mm and 0.1 mm.

According to a preferred embodiment, adjacent tubes arranged side by side are arranged at least partially spaced apart from one another. This allows a tempering fluid (coolant) to flow through the area between the adjacent tubes.

According to a preferred embodiment, the tubes are arranged spatially side by side. Such a three-dimensional arrangement allows for a greater number of tubes in a rectangular or circular cross-sectional area.

According to a preferred embodiment, after step B), a check of the cooler structure is performed and, in the event of detection of a fault, post-processing is performed in the basin. Laser beam processing enables local repairs to openings or leaks.

Further details and advantageous further developments of the invention will emerge from the example embodiments, which are described below and illustrated in the drawings and are not to be construed as limiting the invention in any way. The features mentioned above and those yet to be discussed below can be used not only in the respectively specified combination, but also in other combinations or on their own, without leaving the scope of the present invention.

Parts that are the same or have the same effect are provided with the same reference numbers in the following and are usually described only once. The descriptions of all of the figures build on one another in order to avoid unnecessary repetitions.

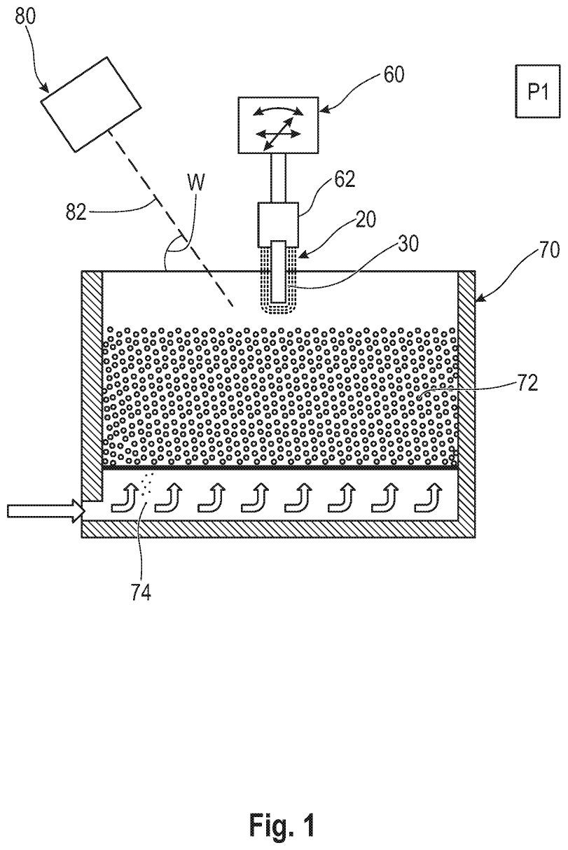

FIG. 1 shows a basin 70 in which a powder 72 is provided. Gas 74, in particular air, can flow in from below, as schematically indicated, and cause the powder 72 to swirl. Such a system may be used as a vortex sintering system.

The powder 72 may be swirled in basin 70 by a gas 74 and thereby fluidized.

A fluidized powder is a powdered material that is placed in a free-flowing state by the supply of gas (for example, air or nitrogen).

Here, the gas flows through the powder discharge. The powder particles are loosened, separated, and partially suspended. The powder 72 behaves similarly to a liquid (“fluidization”).

Fluidization allows for a more even application in a powder coating.

The powder 72 is preferably a resin powder. This allows melting at intended temperatures.

Above the basin 70 is a positioning device 60 with a gripper 62, which may also be referred to generally as a holder. The positioning device 60 preferably allows translation and rotation of the gripper 62, preferably in a plurality of spatial directions and around a plurality of axes.

The translation preferably includes movement in the z-direction such that a depression of the gripper 62 into the basin 70 is possible.

A cooler structure 30 of a cooler 20 is attached to the gripper 62 to enable appropriate positioning of the cooler structure 30.

In the example embodiment, the cooler structure 30 is in a preheating position P1 in which it is heated. For example, a source of infrared radiation or a heat chamber may be used as a heating device.

A laser device 80 is provided and allows for the generation of a laser beam 82.

Preferably, the angle of incidence w of the laser beam 82 may be altered. For example, the position of the laser device 80 can be changed by a translation and/or rotation. Preferably, the laser device 80 has a laser device positioning device for this purpose.

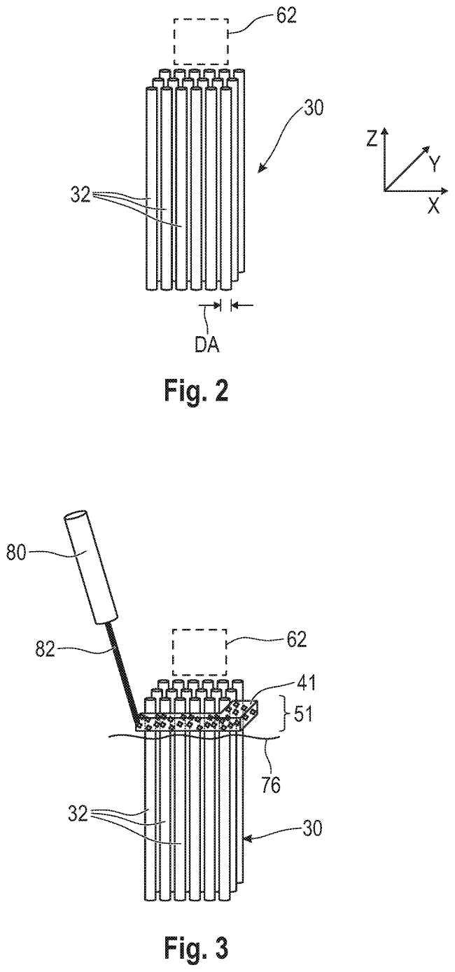

FIG. 2 shows a first step for manufacturing the cooler structure 30. A Cartesian coordinate system with an x-axis, y-axis, and z-axis is drawn as an example.

The cooler structure 30 has tubes 32 arranged side by side and held by the schematically indicated gripper 62.

The tubes 32 may also be referred to as small tubes. They are intended for use in fluid lines and preferably have a hollow cylindrical cross-section.

Preferably, the tubes 32 are arranged parallel to each other.

Preferably, the tubes 32 comprise at least one of the materials form a group of materials consisting of:
metal,
aluminum,
aluminum alloy,
ceramics,
plastic, and
PEEK.

These materials are comparatively light and dimensionally stable, and allow thermal conduction through the tube wall.

Preferably, the tubes 32 arranged side by side are arranged spatially side by side. Thus, the tubes 32 are therefore not arranged in a two-dimensional structure (e.g., offset from each other exclusively in the direction of the x-axis) but in a three-dimensional structure (offset in the direction of the x-axis and in the direction of the y-axis). As a result, a large number of tubes 32 can be arranged in a predetermined space.

In the tubes 32 arranged side by side, the adjacent tubes 32 are arranged at least partially spaced apart from one another, so they do not contact each other. This allows a tempering agent to flow between the tubes 32.

Preferably, the tubes 32 have an outer diameter DA selected from an outer diameter group consisting of:
outer diameter in the range between 4 mm and 5 mm,
outer diameter in the range between 3 mm and 4 mm,
outer diameter in the range between 2 mm and 3 mm,
outer diameter in the range between 1 mm and 2 mm,
outer diameter in the range between 0.5 mm and 1 mm,
outer diameter in the range between 0.1 mm and 0.5 mm, and
outer diameter in the range between 0.01 mm and 0.1 mm.

Thus, these are comparatively small tubes 32. This allows a large number of tubes per unit of space and thus a large surface area of the tubes per unit of space.

With the positioning device 60 of FIG. 1, the cooler structure 30 with the tubes 32 can be positioned in the basin 70 with the powder 72.

FIG. 3 shows the cooler structure 30 positioned in the basin 70 (cf. FIG. 1).

The line 76 indicates the surface of the powder 72. The laser beam 82 of the laser assembly 80 is positioned in the direction of the cooler structure 30.

The powder 72 is locally melted by the laser beam 82 and bonds to the cooler structure in an axial portion 51 of the cooler structure 30 and to powder 72 that has already fused to the cooler structure 30. As a result, a layer 41 of the material of the powder 72 can be formed by the laser beam 82 in the axial portion 51.

Preferably, the layer 41 is materially bonded to the tubes 32.

The layer 41 interconnects the tubes 32 and defines the position of the tubes 32 relative to each other.

The layer 41 extends between and interconnects the tubes 32.

The axial portion 51 is preferably positioned in the area of the surface 76 by the positioning device 60. As a result, the laser beam 82 can heat powder 72 in the desired area without undesirably heating other powder 72 in the basin. On the other hand, the powder 72 comes into the area of the axial portion 51.

Preferably, during processing with the laser beam 82, the angle of incidence w (cf. FIG. 1) of the laser beam 82 is altered relative to the tubes 32 arranged side by side to locally melt powder 72 on different sides of tubes 32. The relative change may be achieved by changing the position of the laser device 80 or by changing the position of the cooler structure.

Prior heating of the cooler structure in the preheating position and heating of the basin 70 allow for acceleration of the method.

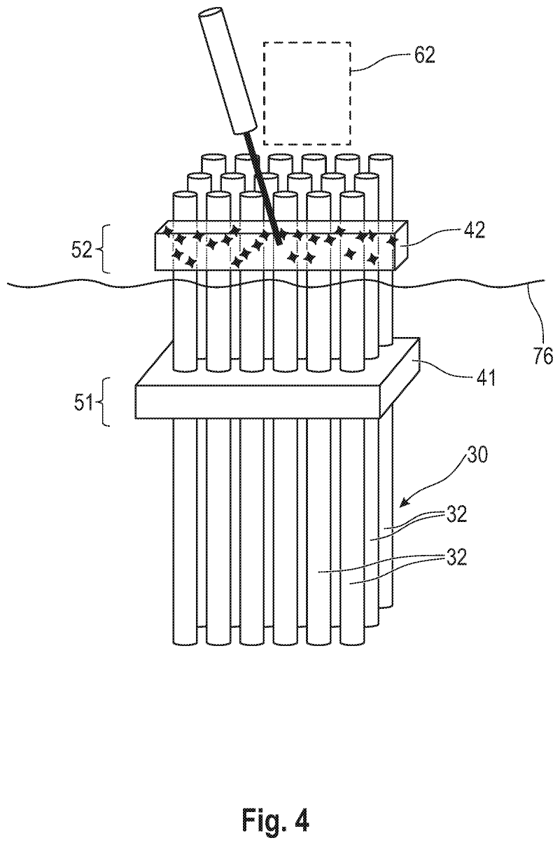

FIG. 4 schematically shows the cooler structure 30 of FIG. 3 in a further method step.

The layer 41 is manufactured.

The cooler structure 30 has been further lowered into the basin 70 such that an axial portion 52 is in the area of the surface 76. The laser device 80 also produces a layer 42 in the axial section 52 by locally melting the powder 72 there.

The layer 42 extends between and interconnects the tubes 32 in the axial portion 52.

Preferably, the layer 42 is spaced apart from the layer 41 at least in sections. This allows a tempering fluid to be passed through in the area between layers 41, 42.

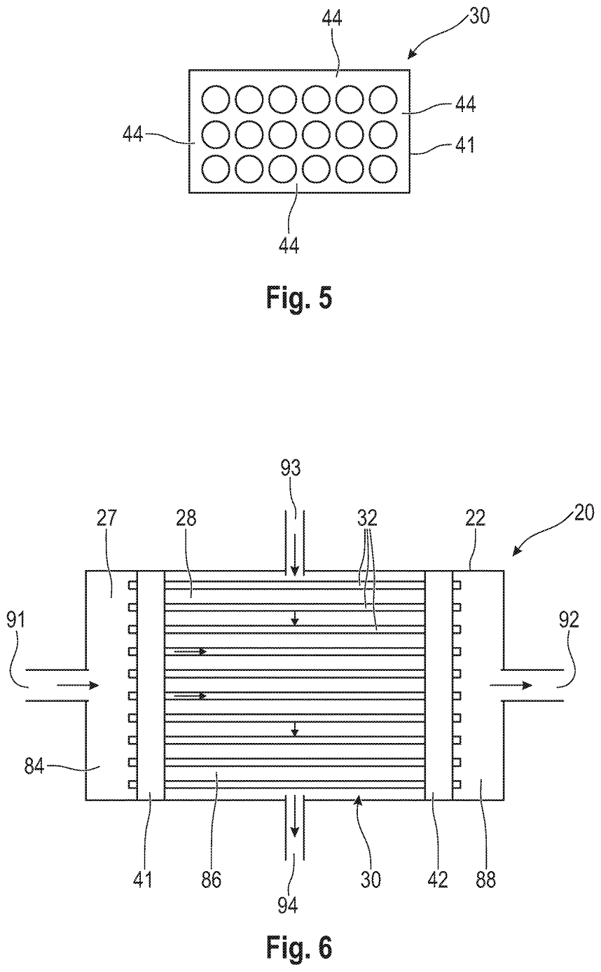

FIG. 5 shows, in a schematic top plan view, the cooler structure 30 with the layer 41.

Preferably, the layer 41 and/or the layer 42 are formed by the laser beam 82 such that they project on the exterior 44 of the tubes 32 arranged side by side. This allows the outer surface 44 to be used to seal the layer 41 and/or 42 against a wall of a housing, and the layer 41 can be held securely against the layer 41 and/or 42 during processing.

FIG. 6 shows the cooler 20 in the assembled state.

The cooler 20 has a housing 22 in which the cooler structure 30 is arranged.

The housing 22 has two inlets 91, 93 and two outlets 92, 94.

The inlet 91 opens into a chamber 84, which is connected to a chamber 88 via the inside of the tubes 32, which in turn is connected to the outlet 92. The tubes 32 extend through the layers 41 and 42.

The inlet 93 is connected to outlet 94 via a chamber 86, with tubes 32 passing through the chamber 86.

Media separation between the chambers 84 and 86 is enabled by the layer 41.

Media separation between the chambers 86 and 88 is enabled by the layer 42.

In the chamber 86, the media are separated by tubes 32, which separate the inside of tubes 32 from their outside in terms of fluid technology.

Further sealing agents for sealing action in the area of the layers 41, 42 can also be provided, for example an adhesive or a rubber seal.

The cooler structure 30 is preferably inserted into the housing 22 for assembly.

Preferably, the layers 41, 42 abut the housing 22 to allow for sealing.

Preferably, the area between the layer 41 and the housing 22 is sealed by the layer 41.

Preferably, the first layer 41 is formed by the laser beam 82 in the area between the tubes 32 arranged side by side such that it fluidly separates the two axially opposite surrounding regions 27, 28 that are separated from one another by the first layer 41. This allows the cooler structure 30 to be used without further sealing measures in this internal area. The fluidic separation may be achieved, for example, by forming the layer 41 with sufficient thickness.

The points given for the layer 41 are equally true for the layer 42 in whole or in part.

Such a cooler 20 may be referred to as a microcooler due to the fine structures. It allows a comparatively high cooling capacity in a small design space. This enables the formation of a high-performance cooler, for example for motor sports.

For example, the cooler 20 may be used with oil as the fluid to be cooled and cooling water as the tempering fluid, or cooling water may be used as the fluid to be cooled and air as the tempering fluid.

The following is a summary of the method for manufacturing the cooler 20 or the cooler structure 30.

A method for manufacturing a cooler 20 having a cooler structure 30, wherein the cooler structure 30 comprises a plurality of tubes 32 arranged side by side and a first layer 41, wherein the first layer 41 extends between the tubes in a first axial portion 51 of the tubes 32 arranged side by side and connects said tubes 32 to one another, comprising the following steps:
A) the tubes 32 arranged side by side are positioned with a positioning device 60 in a basin 70 having a powder 72 for powder coating; and
B) the powder 72 is locally melted in the first axial portion 51 of the tubes 32 arranged side by side by a laser beam 82, and the first layer 41 is thereby formed from the molten powder 72.

Preferably, in the method, a second layer 42 is formed, wherein the second layer 42 extends in and interconnects between the tubes 32 in a second axial portion 52, wherein the second layer 42 is spaced apart from the first layer 41 at least in sections, and wherein the method comprises the steps of:
C) after step B), the position of the tubes 32 arranged side by side in the basin 70 is changed, the powder 72 is locally melted in the second axial portion 52 of the tubes 32 arranged side by side by a laser beam 82, and the second layer 42 is thereby formed from the molten powder 72.

Preferably, after step B), a check of the cooler structure 30 is performed and, in the event of detection of a fault, post-processing is performed in the basin 70.

The control can be performed optically, with an X-ray apparatus, for example, or by means of a leak measurement.

The inspection can be visual.

The tightness can be achieved in a process-safe manner.

Many variants and modifications are of course possible within the scope of embodiments the present disclosure.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for manufacturing a cooler having a cooler structure, wherein the cooler structure comprises a plurality of tubes arranged side by side and a first layer, wherein the first layer extends between tubes of the plurality of tubes in a first axial portion of the tubes and connects the tubes to one another, the method comprising:
A) positioning, with a positioning device, the tubes arranged side by side in a basin having a powder for powder coating; and
B) locally melting, by a laser beam, the powder in the first axial portion of the tubes arranged side by side, thereby forming the first layer from the molten powder.

2. The method according to claim 1, wherein the cooler structure comprises a second layer, wherein the second layer extends in a second axial portion between the tubes and connects the tubes to one another, wherein the second layer is at least partially spaced apart from the first layer, the method further comprising the steps of:
C) after step B), changing a position of the tubes arranged side by side in the basin, locally melting, by the laser beam, the powder in the second axial portion of the tubes arranged side by side, and thereby forming the second layer from the molten powder.

3. The method according to claim 1, wherein the method is performed with tubes comprising at least one of the materials selected from a group of materials consisting of: metal, aluminum, aluminum alloy, ceramics, plastic, and polyether ether ketone (PEEK).

4. The method according to claim 1, wherein the powder in the basin is swirled through a gas and thereby fluidized.

5. The method according to claim 1, wherein during step B), an angle of incidence of the laser beam is altered relative to the tubes arranged side by side in order to locally melt the powder on different sides of the tubes.

6. The method according to claim 1, wherein the cooler comprises a housing, wherein the cooler structure is inserted into the housing, and wherein the first layer at least partially abuts the housing.

7. The method according to claim 1, wherein the positioning device comprises a gripper, and wherein the tubes arranged side by side in step A) are held by the gripper.

8. The method according to claim 1, wherein the tubes arranged side by side before step A) are heated in a preheating position.

9. The method according to claim 1, wherein the first layer is formed by the laser beam such that the first layer protrudes on an outside of the tubes arranged side by side.

10. The method according to claim 1, wherein the first layer is formed by the laser beam in an area between the tubes arranged side by side such that the area fluidly separates two axially opposite surrounding regions that are separated from one another by the first layer.

11. The method according to claim 1, wherein a resin powder is used in the basin as the powder.

12. The method according to claim 1, wherein tubes having a first outer diameter are used at least partially as the tubes arranged side by side, wherein the first outer diameter is selected from an outer diameter group consisting of:
an outer diameter in the range between 4 mm and 5 mm,
an outer diameter in the range between 3 mm and 4 mm,
an outer diameter in the range between 2 mm and 3 mm,
an outer diameter in the range between 1 mm and 2 mm,
an outer diameter in the range between 0.5 mm and 1 mm,
an outer diameter in the range between 0.1 mm and 0.5 mm, and
an outer diameter in the range between from 0.01 mm to 0.1 mm.

13. The method according to claim 1, wherein adjacent tubes of the tubes arranged side by side are arranged at least partially spaced apart from one another.

14. The method according to claim 1, wherein the tubes arranged side by side are spatially arranged side by side.

15. The method according to claim 1, further comprising carrying out a check of the cooler structure after step B), during which, in the event of a detection of a fault, carrying out post-processing in the basin.
